(19) United States
(12) Patent Application Publication
(10) Pub. No.: US 2005/0162790 A1
(43) Pub. Date: Jul. 28, 2005

(54) Electrostatic discharge protection circuit

(75) Inventor: Hiroyuki Yoshinaga, Saitama-shi (JP)

Correspondence Address: FOLEY AND LARDNER;SUITE 500, 3000 K STREET NW, WASHINGTON, DC, 20007, US

(73) Assignee: KABUSHIKI KAISHA TOSHIBA

(21) Appl. No.: 10/924,195

(22) Filed: Aug. 24, 2004

(30) Foreign Application Priority Data
Jan. 28, 2004 (JP) 2004-020134

(51) Int. Cl. H02H 9/00

(52) U.S. Cl. 361/56

(57) ABSTRACT

An electrostatic discharge protection circuit comprises an input terminal, an output terminal connected to the input terminal via a transmission line, and connected to a circuit to be protected, and a filter circuit disposed in the transmission line, wherein the filter circuit includes at least one inductor disposed in the transmission line between the input terminal and the output terminal, and connected in series when a plurality of inductors are arranged, and at least one electrostatic discharge protection device connected between the transmission line and a reference potential line, the filter circuit being symmetrically configured in terms of an equivalent circuit between the input terminal and the output terminal.

### CROSS-REFERENCE TO RELATED APPLICATIONS

This application is based upon and claims the benefit of priority from prior Japanese Patent Application No. 2004-020134, filed Jan. 28, 2004, the entire contents of which are incorporated herein by reference.

### BACKGROUND OF THE INVENTION

1. Field of the Invention

The present invention relates to an electrostatic discharge protection circuit of an electronic circuit including an integrated circuit.

2. Description of the Related Art

Miniaturization of integrated circuits has advanced year by year. Accordingly, electrostatic breakdown voltages of semiconductor devices such as transistors have dropped, and protection circuits against electrostatic discharge (hereinafter referred to as ESD) have become important. Protection characteristics against ESD are defined by various published test standards, and a human body model (HBM), a machine model (MM), and a charged device model (CDM) are applied in accordance with products. These standards specify protection performances at the time ESD is applied, and the integrated circuit products are designed to satisfy these standards.

To normally operate an internal circuit to be protected, an ESD protection circuit is required to show a high impedance and to operate in such a manner that the circuit can be handled as if there were no protection circuit. On the other hand, when static electricity is applied to a power supply, an input/output terminal or the like, the ESD circuit needs to operate as a low-impedance circuit to discharge the static electricity and operate in order to prevent a voltage which damages an internal electric circuit from being applied.

As a protection device used in the ESD protection circuit, a large number of devices have been devised such as a device using the reverse-direction withstand characteristic of a diode, a device using a forward-direction rising voltage, and a device using a thyristor. The circuits are configured by using devices which operate with a high impedance at a predetermined voltage or lower, and with a low impedance with respect to the voltage higher than the predetermined voltage.

For example, in Published Japanese translations of PCT international publication 2000-510653, an ESD protection device, and an inductor or transmission line element are designed as a pair of L-type circuits, and are cascade-connected in a multiplex manner, and an inductance is set to Z=(Lout/Cout)^{0.5}. By use of such a distributed ESD protection circuit, there can be provided an ESD protection device in which bandwidth is not decreased even in a high-frequency device.

As described above, the ESD protection circuit shows a high impedance when no ESD is applied, but in actual use, a leakage current, a parasitic reactance or the like exists and a microcurrent flows. Especially, the ESD protection circuit shows a capacitive parasitic reactance with respect to a high-speed pulse signal or a high-frequency signal, so that the impedance of the ESD protection circuit, which should originally be high, drops. Therefore, there is a problem that a signal voltage transmitted to the internal circuit via the ESD protection circuit drops. This is a factor which limits the operation frequency or high-speed response characteristics of the circuit. Therefore, there has been a demand for an ESD protection circuit in which there is little signal deterioration against a high-speed, high-frequency signal.

### BRIEF SUMMARY OF THE INVENTION

According to a first aspect of the invention, there is provided an electrostatic discharge protection circuit, which comprises:
an input terminal;
an output terminal connected to the input terminal via a transmission line, and connected to a circuit to be protected; and
a filter circuit disposed in the transmission line,
the filter circuit including:
   at least one inductor disposed in the transmission line between the input terminal and the output terminal, and connected in series when a plurality of inductors are arranged; and
   at least one electrostatic discharge protection device connected between the transmission line and a reference potential line, the filter circuit being symmetrically configured in terms of an equivalent circuit between the input terminal and the output terminal.

Furthermore, according to a second aspect of the invention, there is provided an electrostatic discharge protection circuit, which comprises:
a first power supply line to which a power voltage is supplied;
a second power supply line connected to ground potential;
an internal circuit connected to the first power supply line and the second power supply line, and having an internal input terminal;
a bidirectional electrostatic discharge protection device connected between the first power supply line and the second power supply line;
a first and a second unidirectional electrostatic discharge protection device connected in series between the first power supply line and the second power supply line;
an external input terminal to which an external signal is supplied;
a first inductor connected between the external input terminal and a connection node of the first and the second unidirectional electrostatic discharge protection device; and
a second inductor connected between the connection node of the first and the second unidirectional electrostatic discharge protection device and the internal input terminal.

Furthermore, according to a third aspect of the invention, there is provided a semiconductor integrated circuit, which comprises:
a semiconductor substrate;
a reference potential line formed on the semiconductor substrate;
an input terminal which is formed on the semiconductor substrate and which receives an external input signal;
an output terminal which is formed on the semiconductor substrate and which is connected to the input terminal via a transmission line and which supplies an internal input signal;
a filter circuit disposed in the transmission line,
the filter circuit including:
   at least one inductor disposed in the transmission line between the input terminal and the output terminal, and connected in series when a plurality of inductors are arranged;
   at least one electrostatic discharge protection device connected between the transmission line and a reference potential line, the filter circuit being symmetrically configured in terms of an equivalent circuit between the input terminal and the output terminal; and
   an internal circuit to which the internal input signal is supplied from the output terminal.

### BRIEF DESCRIPTION OF THE SEVERAL VIEWS OF THE DRAWING

FIG. 1 is a circuit diagram of an ESD protection circuit (T-type) according to a first embodiment;

FIG. 2 is a sectional view of an ESD protection device for use in the embodiment of the present invention;

FIG. 3 is a plan view of the ESD protection device for use in the embodiment of the present invention;

FIG. 4 is a sectional view of another ESD protection device for use in the embodiment of the present invention;

FIG. 5 is a plan view of another ESD protection device for use in the embodiment of the present invention;

FIG. 6 is a sectional view of still another ESD protection device for use in the embodiment of the present invention;

FIG. 7 is a plan view of still another ESD protection device for use in the embodiment of the present invention;

FIG. 8 is a sectional view of still another ESD protection device for use in the embodiment of the present invention;

FIG. 9 is a plan view of still another ESD protection device for use in the embodiment of the present invention;

FIG. 10 is a diagram showing that the ESD protection device is equivalent to a capacitor;

FIG. 11 is a diagram showing the circuit of FIG. 1 in an equivalent circuit;

FIG. 12 is a circuit diagram for calculating an output voltage of a protection circuit in which only the ESD protection device is used;

FIG. 13 is a circuit diagram for calculating an output voltage of the protection circuit of the first embodiment;

FIG. 14 is a diagram in which frequency characteristics of the output voltage of the protection circuit of the first embodiment are compared with those of the output voltage of a conventional circuit only of the ESD protection device;

FIG. 15 is a circuit diagram showing the first embodiment more concretely;

FIG. 16 is a circuit diagram of an ESD protection circuit (multistage T-type) according to a second embodiment;

FIG. 17 is a characteristic diagram showing a change of output voltage frequency characteristics by the number of stages of a T-type protection circuit;

FIG. 18 is a characteristic diagram showing dependence of frequency characteristics of the output voltage of the T-type protection circuit on an inductance value;

FIG. 19 is an enlarged view of a part of 6 to 11 GHz of FIG. 18;

FIG. 20 is a diagram showing a dependence of the frequency characteristics of the output voltage of the two-stage protection circuit of FIG. 16 on the inductance value;

FIG. 21 is a circuit diagram showing the second embodiment more concretely;

FIG. 22 is a circuit diagram of the ESD protection circuit according to a first modification of the second embodiment;

FIG. 23 is a circuit diagram showing the first modification of the second embodiment more concretely;

FIG. 24 is a circuit diagram of the ESD protection circuit (π-type) according to a third embodiment;

FIG. 25 is a circuit diagram showing the third embodiment more concretely;

FIG. 26 is a circuit diagram of the ESD protection circuit according to a first modification of the third embodiment;

FIG. 27 is a circuit diagram showing the first modification of the third embodiment more concretely;

FIG. 28 is a circuit diagram of the ESD protection circuit according to a second modification of the third embodiment;

FIG. 29 is a circuit diagram of the ESD protection circuit according to a third modification of the third embodiment;

FIG. 30 is a circuit diagram of the ESD protection circuit according to a fourth modification of the third embodiment;

FIG. 31 is a circuit diagram of the ESD protection circuit (multistage π-type) according to a fourth embodiment;

FIG. 32 is a circuit diagram showing the fourth embodiment more concretely;

FIG. 33 is a circuit diagram of the ESD protection circuit according to a first modification of the fourth embodiment;

FIG. 34 is a characteristic diagram showing the output voltage frequency characteristics of the π-type protection circuit of FIG. 33 in comparison with those of a conventional protection circuit of only the ESD protection device;

FIG. 35 is a circuit diagram of the ESD protection circuit according to a first modification of the fourth embodiment;

FIG. 36 is a circuit diagram of the ESD protection circuit according to a second modification of the fourth embodiment;

FIG. 37 is a circuit diagram of the ESD protection circuit according to a third modification of the fourth embodiment;

FIG. 38 is a circuit diagram of the ESD protection circuit according to a fourth modification of the fourth embodiment;

FIG. 39 is a circuit diagram of the ESD protection circuit according to a fifth modification of the fourth embodiment;

FIG. 40 is a circuit diagram of an input protection circuit showing an operation of an application example of the present invention;

FIG. 41 is a circuit diagram of the input protection circuit showing the operation of the application example of the present invention;

FIG. 42 is a circuit diagram of a case where the embodiment of FIG. 15 is applied to the input protection circuit of FIG. 40 (41);

FIG. 43 is an equivalent circuit diagram for use in calculation of a comparative example (prior-art example) in FIG. 14; and

FIG. 44 is a schematic sectional view of a semiconductor integrated circuit comprising an electrostatic discharge protection circuit of the present invention.

### DETAILED DESCRIPTION OF THE INVENTION

According to embodiments of the present invention described hereinafter, in an ESD protection circuit, an ESD protection device is connected to an inductor, a parasitic capacitive reactance is compensated for, and further the connected inductor and protection device constitute a filter. Accordingly, an ESD protection circuit can be realized which produces little signal degradation of a high-speed, high-frequency signal.

The embodiments of the present invention will be described hereinafter with reference to the drawings.

### FIRST EMBODIMENT

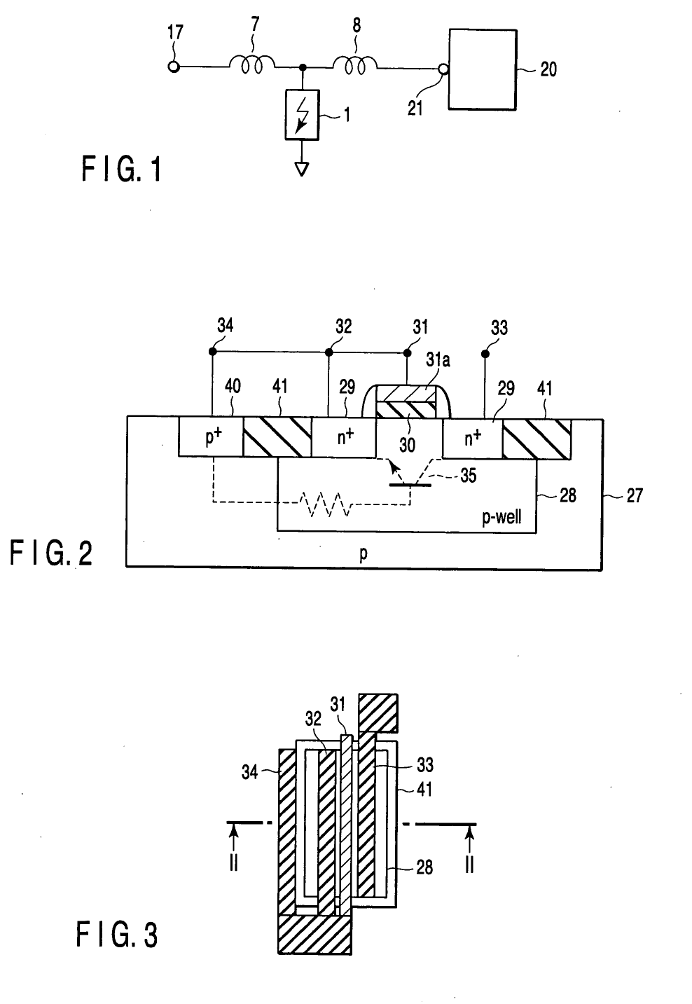

FIG. 1 is a circuit diagram of an ESD protection circuit according to a first embodiment. The protection circuit comprises an ESD protection device 1, inductors 7, 8, an input terminal 17, and an output terminal 21 connected to an internal circuit 20. It is to be noted that the input terminal 17 corresponds to an external terminal, for example, in an integrated circuit device, and is sometimes an output terminal in actual use. Therefore, although the terminal is exactly an input/output terminal, the terminal is referred to as an input terminal in a meaning that an electrostatic breakdown voltage is applied to the terminal.

For example, as shown in FIG. 2, a protection device using NMOSFET is usable in the ESD protection device. FIG. 2 shows a sectional configuration of a so-called gate grounded NMOS (ggNMOS). This is a two-terminal configuration in which a drain terminal 33 is assumed as one terminal, and a source terminal 32 connected to a gate terminal 31 and a body terminal 34 is assumed as the other terminal. Protection device characteristics are realized using switching characteristics of a parasitic bipolar transistor formed of n⁺ diffusion layers 29, serving as a source and drain, and a p-well region 28. It is to be noted that in FIG. 2, reference numeral 27 denotes a p-substrate, 30 denotes a gate dielectric layer, 31a denotes a gate electrode, and 41 denotes a shallow trench isolation (STI) region. FIG. 3 is a plan view of the device. A device region surrounded with the STI region 41 is designed in an area several hundred times that of a small-signal MOSFET for use in a normal integrated circuit, and an occupying area in the integrated circuit is large. It is to be noted that FIG. 2 corresponds to a sectional view of FIG. 3 along line II-II.

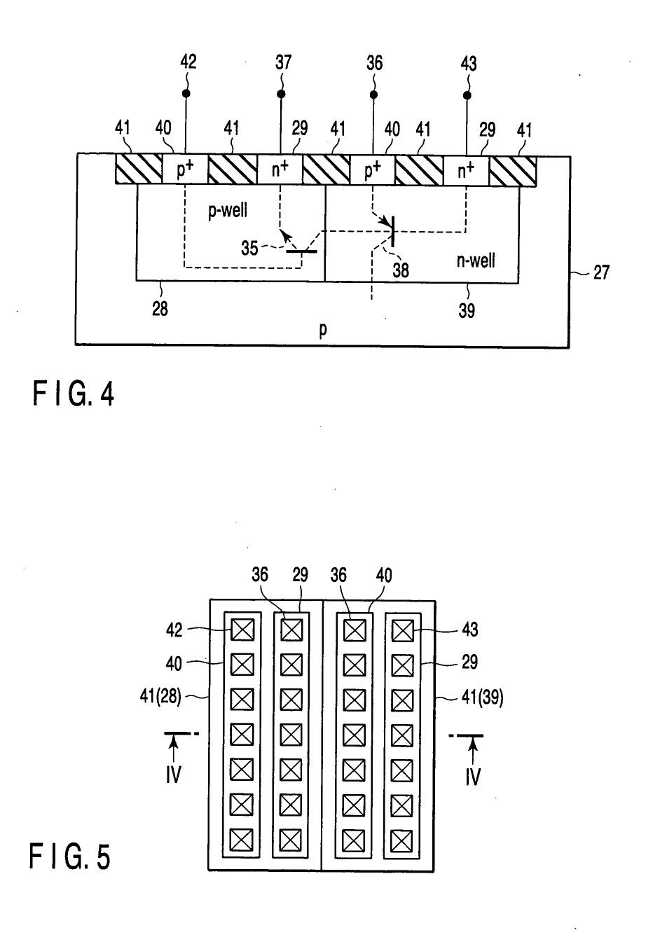

For example, a thyristor shown in FIG. 4 may also be used in the ESD protection device. In the p-substrate 27, the p-well 28 and an n-well 39 are formed, and the n⁺ layer 29 and a p⁺ layer 40 are selectively formed in a surface region divided by the STI regions 41. A parasitic pnp-transistor 38 formed in the n-well region 39, and a parasitic npn-transistor 35 formed in the p-well 28 form a parasitic thyristor. Reference numeral 42 denotes a first gate terminal, 43 denotes a second gate terminal, 36 denotes an anode, 37 denotes a cathode, and two terminals including the anode 36 and cathode 37 are used as the terminals of the ESD protection device.

FIG. 5 is a schematic plan view of the device. In the region divided by the STI region 41, the p⁺ region 40, n⁺ region 29, p⁺ region 40, and n⁺ region 29 are juxtaposed and formed. As the number of constituent elements becomes larger in comparison with the case of MOSFET, the occupying area also increases. It is to be noted that FIG. 4 corresponds to a sectional view along line IV-IV of FIG. 5.

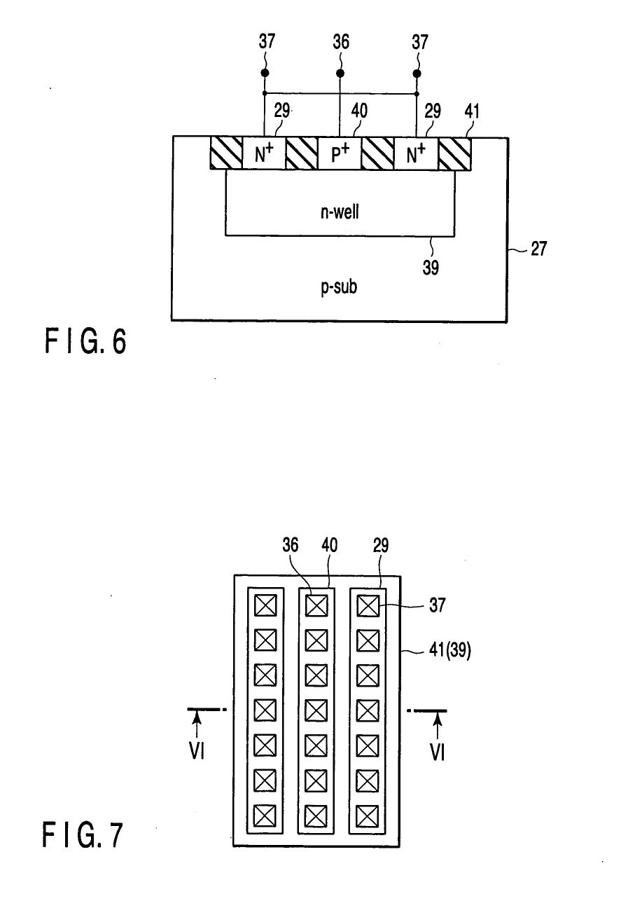

Diodes, for example, shown in FIGS. 6 to 9 may also be used in the ESD protection device. It is to be noted that in these drawings, the same portions as those of FIG. 4 are denoted with the same reference numerals. In FIG. 6, the n-well 39 is formed in the p-substrate 27, and the p⁺ layer 40 and n⁺ layer 29 are selectively formed in the surface region divided by the STI regions 41. The diode is formed by PN-junction of an interface between the p⁺ layer 40 and the n-well 39. FIG. 7 is a schematic plan view of the device. The n⁺ region 29, p⁺ region 40, and n⁺ region 29 are formed in parallel in a region divided by the STI region 41. It is to be noted that FIG. 6 corresponds to a sectional view along line VI-VI of FIG. 7.

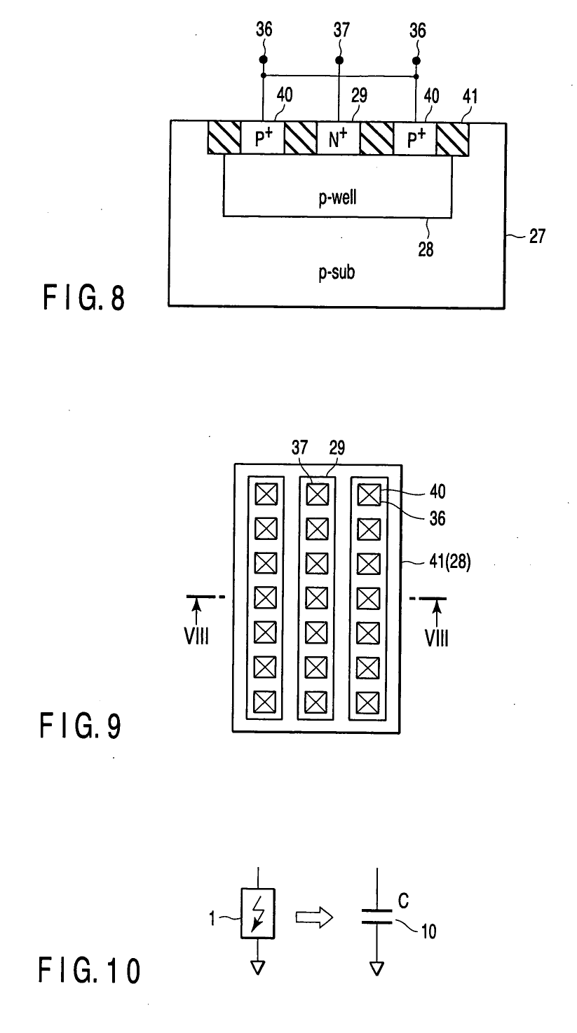

In FIG. 7, the diode is formed in the n-well, but may also be formed using a p-well. In FIG. 8, the p-well 28 is formed in the p-substrate 27, and the p⁺ layer 40 and n⁺ layer 29 are selectively formed in the surface region divided by the STI regions 41. The PN-junction of the interface between the n⁺ layer 29 and the p-well 28 forms a diode. FIG. 9 is a schematic plan view of the device. The p⁺ region 40, n⁺ region 29, and p⁺ region 40 are formed in parallel in the region divided by the isolation regions 41. It is to be noted that FIG. 8 corresponds to a sectional view along line VIII-VIII of FIG. 9.

Additionally, the ESD protection device 1 indicates high-impedance characteristics, when a voltage for usually operating the internal circuit 20 is applied to the input terminal 17, and this state is referred to as an off-state. On the other hand, when a high-voltage is applied as ESD to the input terminal 17, remarkably low impedance characteristics are shown, and this state is referred to as an on-state.

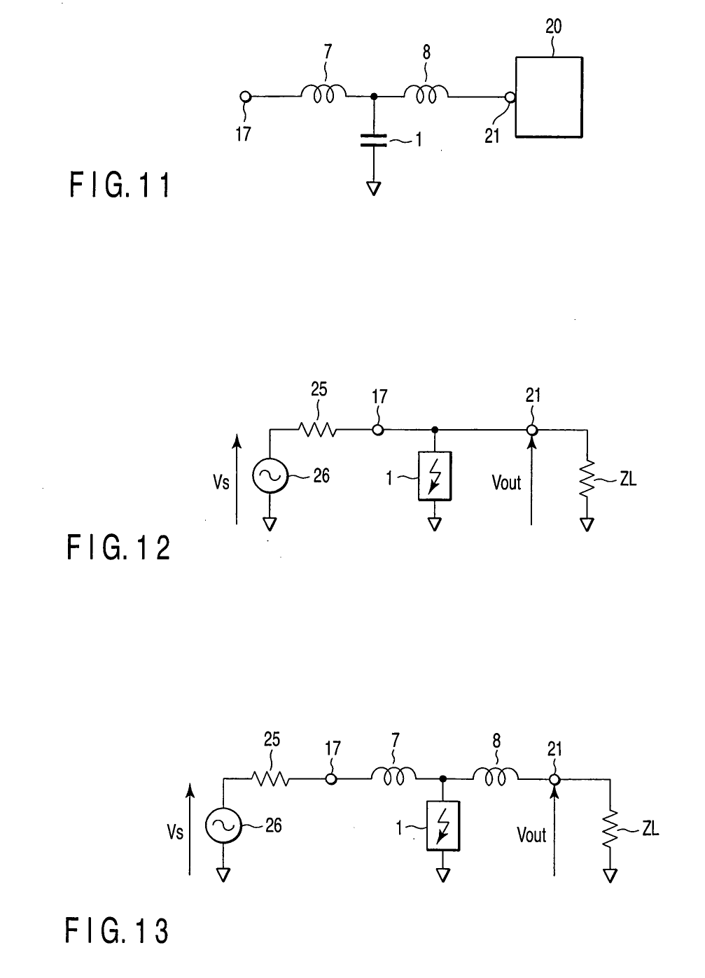

The ESD protection device operates mainly in the on-state, and improvements in performance of the ESD protection device in the off-state in which the device does not perform a protective operation will be described in the present embodiment. When the ESD protection device is in the off-state, the ESD protection device 1 can be represented by a parasitic capacitance as shown in the equivalent circuit of FIG. 10. Therefore, FIG. 1 can be represented by a T-type LC circuit in an equivalent manner as shown in FIG. 11. The circuit configuration is that of a basic circuit of a low-pass filter. When an inductance L is designed in accordance with a parasitic capacitance value, the filter can be designed to form the low-pass filter or a band-pass filter.

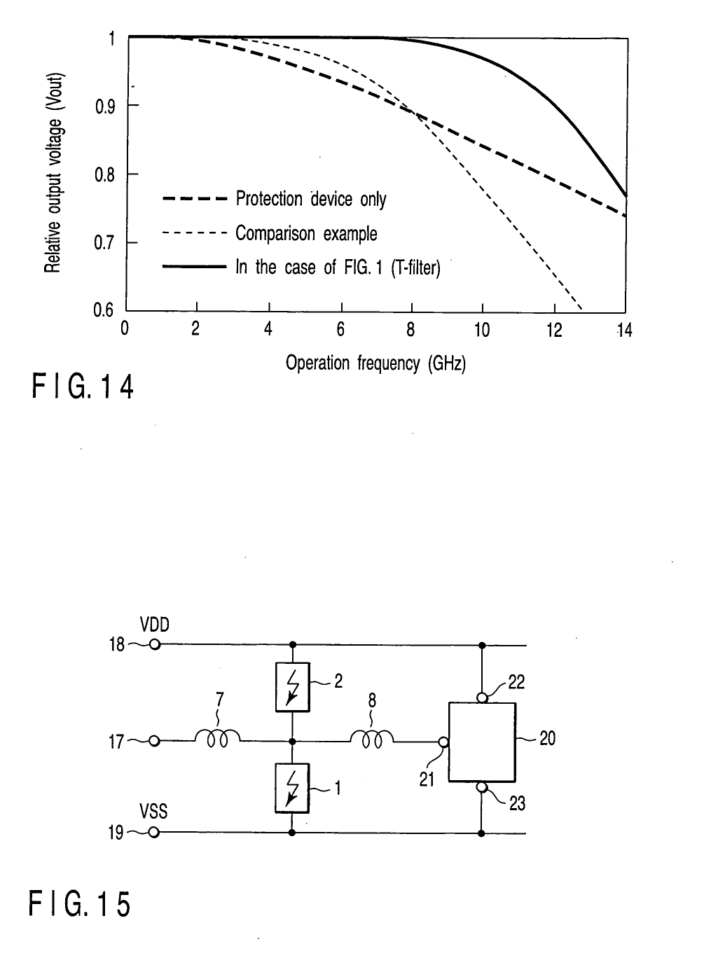

For example, when the filter is designed to form a low-pass filter, a pass band can be designed to be broad as compared with a single parasitic capacitance by the ESD protection device. FIG. 12 shows an equivalent circuit for calculating output voltages generated at opposite ends of an input impedance ZL of an internal circuit in a case where an ESD protection device is connected between the input terminal and the ground potential, and FIG. 13 similarly shows an equivalent circuit for calculating the output voltages generated in the opposite ends of the input impedance ZL of the internal circuit in the first embodiment of the present invention.

Here, assuming that the parasitic capacitance of the ESD protection device 1 is 0.4 pF and that the inductance (7, 8) in FIG. 13 is 0.6 nH, the output voltage Vout is calculated. It is assumed that an internal impedance (25) Zs of a power supply 26, and an input impedance ZL of the internal circuit 20 indicate 50Ω, Vs of an alternating voltage supply is 2V (effective value), and an output voltage Vout is 1V (effective value).

FIG. 14 shows the output voltage Vout calculated in FIGS. 12 and 13 in accordance with an operation frequency of the internal circuit. As shown by a long dashed line of FIG. 14, in the configuration only of the ESD protection device 1, when the frequency increases, the output voltage gradually drops in the vicinity of 2 GHz. On the other hand, in the first embodiment of the present invention, it is seen that the output voltage hardly drops in the vicinity of 8 GHz as shown by a solid line of FIG. 14, and the output voltage rapidly drops when exceeding 10 GHz.

Since the ESD protection circuit is configured in a T-type filter circuit in this manner in the first embodiment, the drop of the output voltage with the increase of the frequency can be largely reduced by the parasitic capacitance of the ESD protection device.

Moreover, the filter circuit includes two inductors connected in series between the input terminal 17 and the output terminal 21, and an ESD protection device connected between a transmission line (an interconnection), which connects the input terminal 17 and the output terminal 21, and a reference potential (ground potential in this case), and is configured symmetrically between the input terminal and the output terminal. Therefore, assuming that the input impedance of the internal circuit 20 is 50Ω, the input impedance viewed from the input terminal 17 can be set to 50Ω.

As in a protection circuit of the published Japanese translations of PCT international publication 2000-510653, the ESD protection device and the inductor are formed as a pair of L-type circuits, and cascade-connected in a multiplex manner. When similar calculation is performed with respect to a transmission line of the circuit as a comparative example, as shown by a short dashed line in FIG. 14, an advantage of compensating for the output voltage drop is considerably small as compared with the circuit of the present invention. It is to be noted that an equivalent circuit for the calculation of the comparative example is shown in FIG. 43. This circuit is asymmetrical between the input terminal 17 and the output terminal 21. It is to be noted that in the calculation of the comparative example, the configuration includes a single ESD protection device and a single inductor, the parasitic capacitance is set to 0.4 pF for the comparison, and the inductance is set to 1 nH. In this manner, there is a large difference in the advantage between the present embodiment and the comparative example, and this respect indicates the usefulness of the present embodiment.

FIG. 15 shows a more practical circuit configuration of the first embodiment. A power terminal VDD 18 and a ground terminal VSS 19 are added to the circuit of FIG. 1, and a second protection device 2 is added between a power supply VDD and a connection node of the inductances 7, 8. Therefore, the configuration is effective not only when the ESD is applied between the input terminal 17 and the VSS terminal 19 but also when the ESD is applied between the input terminal 17 and the VDD terminal 18. It is to be noted that the equivalent circuit of the circuit of FIG. 15 is represented as shown in FIG. 1, and the ESD device 1 is inserted between the transmission line and the reference potential (VSS or VDD) in the drawing.

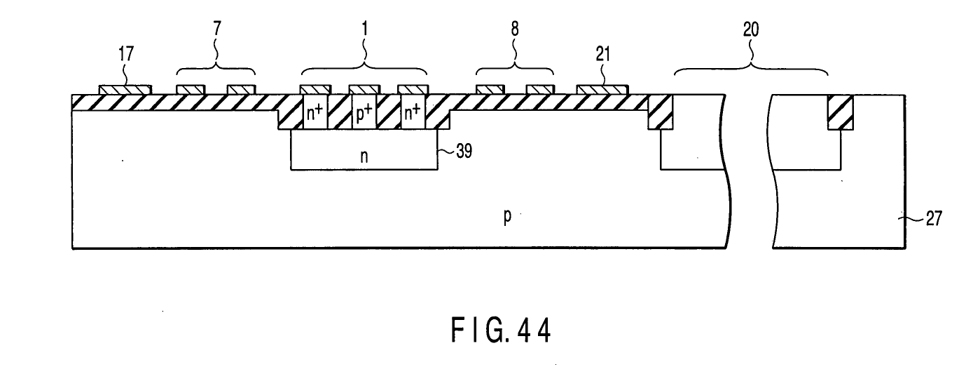

FIG. 44 shows a schematic sectional view of an integrated circuit in which the ESD protection circuit of the first embodiment is installed. The input terminal 17, inductors 7, 8, and output terminal 21 are formed on the semiconductor substrate 27 in an insulated manner. The ESD protection device illustrates the diode. Reference numeral 20 denotes an internal circuit which is a circuit to be protected.

### SECOND EMBODIMENT

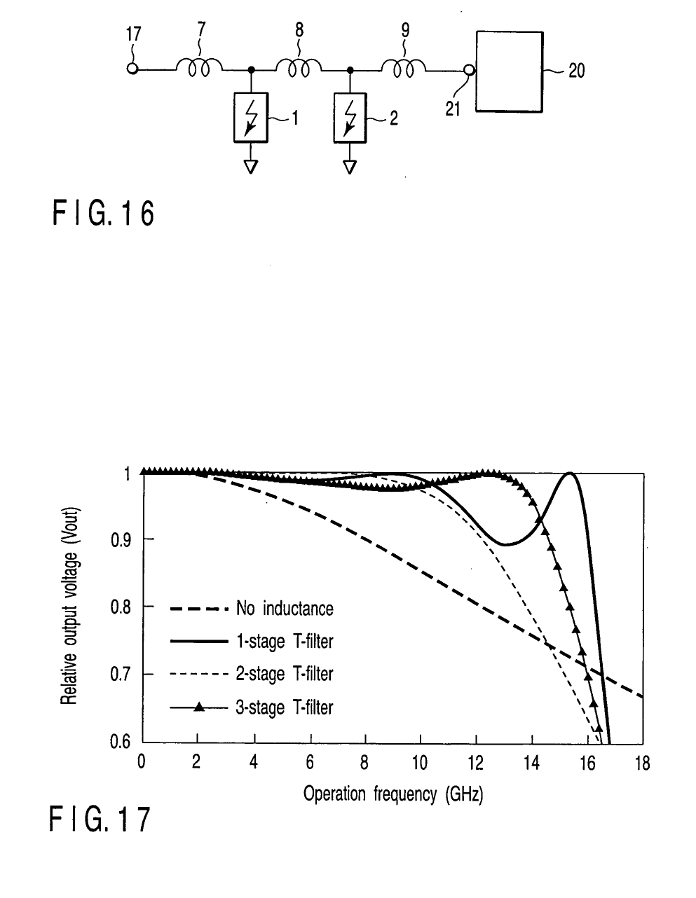

FIG. 16 is a circuit diagram of an ESD protection circuit according to a second embodiment. The second embodiment is a modification of the first embodiment, and the number of stages of the T-type circuit of FIG. 1 is increased. Even this configuration is symmetrical between the input/output terminals 17, 21. In the frequency characteristics of the circuit of FIG. 16, the optimum range can be expanded further in a direction of high frequency as compared with that of the circuit of FIG. 1. The frequency characteristics will be described hereinafter in detail.

FIG. 17 shows dependence of operation frequency characteristics of a relative output voltage on the number of stages, and four cases are compared. That is, the output voltage characteristics are compared in cases where there is not any compensation by inductance, where the T-type circuit formed of the ESD protection device 1 and the inductors 7, 8 has one stage as shown in FIG. 1, where the T-type circuit formed of the ESD protection devices 1, 2 and inductors 7, 8, 9 has two stages as shown in FIG. 16, and where another ESD protection device and another inductor are added to FIG. 16 to form a three-stage T-type circuit (any circuit diagram is not shown). It is seen that with the increase of the number of stages, a frequency range in which the voltage drop is compensated for is expanded in a high frequency direction, but the output voltage rapidly drops outside the upper end of the frequency range. There is also a difference in the frequency characteristics depending on whether the number of stages is even or odd.

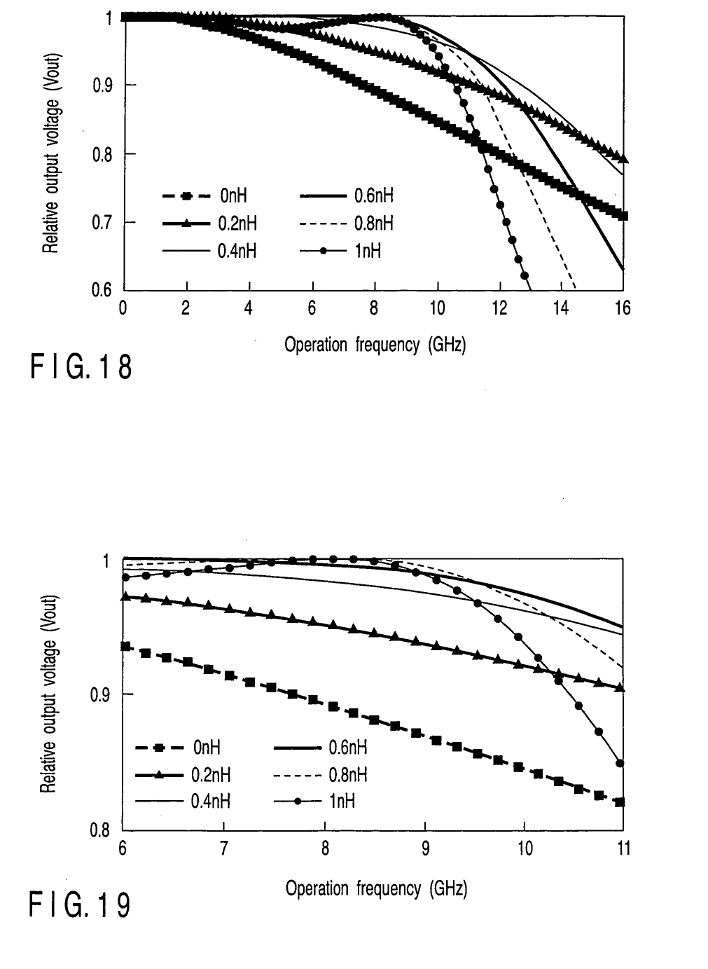

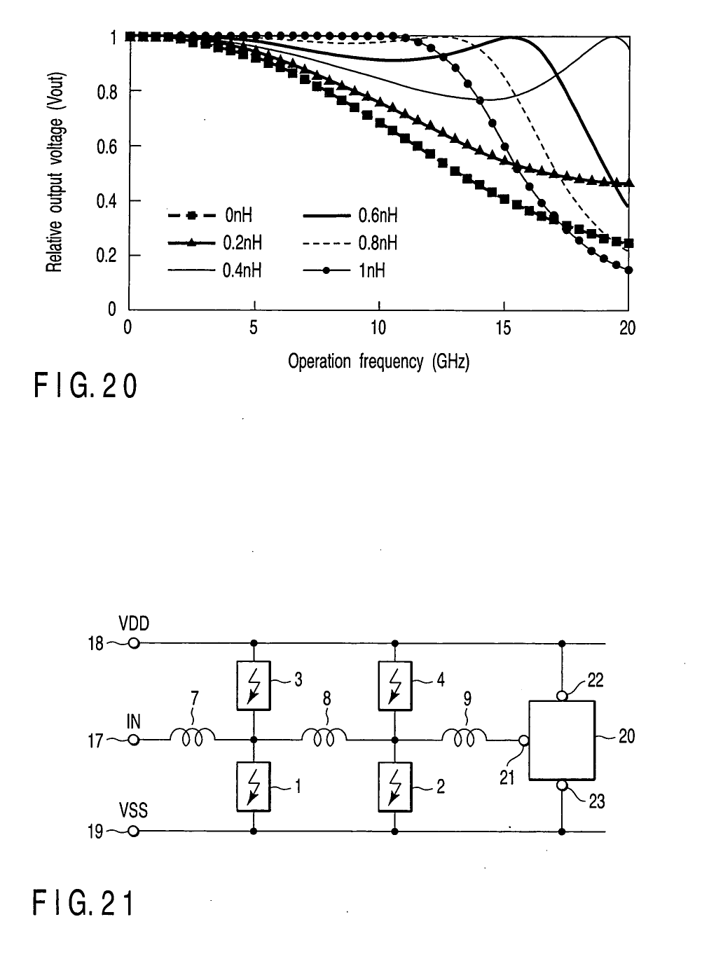

Next, an output voltage characteristic example at a time when the inductances of the inductors 7, 8 in the circuit of FIG. 1 are changed to 1 nH from 0 nH every 0.2 nH is shown in FIG. 18. FIG. 19 is an enlarged view of the characteristics in a range of 6 to 11 GHz. When the inductance increases, the output voltage on a high frequency side increases, and the compensation is performed. However, when the inductance is excessively large, output voltage characteristics on the high-frequency side are remarkably degraded. Therefore, it is seen that an optimum value of the inductance exists in accordance with a desired frequency range and the output voltage specification. FIG. 20 shows output voltage characteristics at a time when the inductance value of the inductor 8 in the two-stage T-type shown in FIG. 16 is changed to 1 nH from 0 nH every 0.2 nH. When the inductance of the inductor 8 is 0.4 nH, the output voltage indicates a value close to 1 even at 20 GHz. However, the voltage drops in the vicinity of 13 to 15 GHz, showing a ripple therearound. When the inductance is further increased, the frequency indicating a peak drops, but the ripple is reduced. It is found that the size of the ripple and the peak frequency can be optimized in order to obtain desired characteristics.

FIG. 21 shows a more practical circuit configuration of the embodiment of FIG. 16. The power supply terminal VDD 18 and ground terminal VSS 19 are added to the circuit of FIG. 16, and second protection devices 3, 4 are added between the power supply VDD and the opposite ends of the protection device 8. Therefore, the configuration becomes effective not only when the ESD is applied between the input terminal 17 and the VSS terminal 19 but also when the ESD is applied between the input terminal 17 and the VDD terminal 18. It is to be noted that the circuit diagram of FIG. 21 is represented by an equivalent circuit as shown in FIG. 16, and the ESD devices 1, 2 are inserted between the transmission line and the reference potential (VSS or VDD).

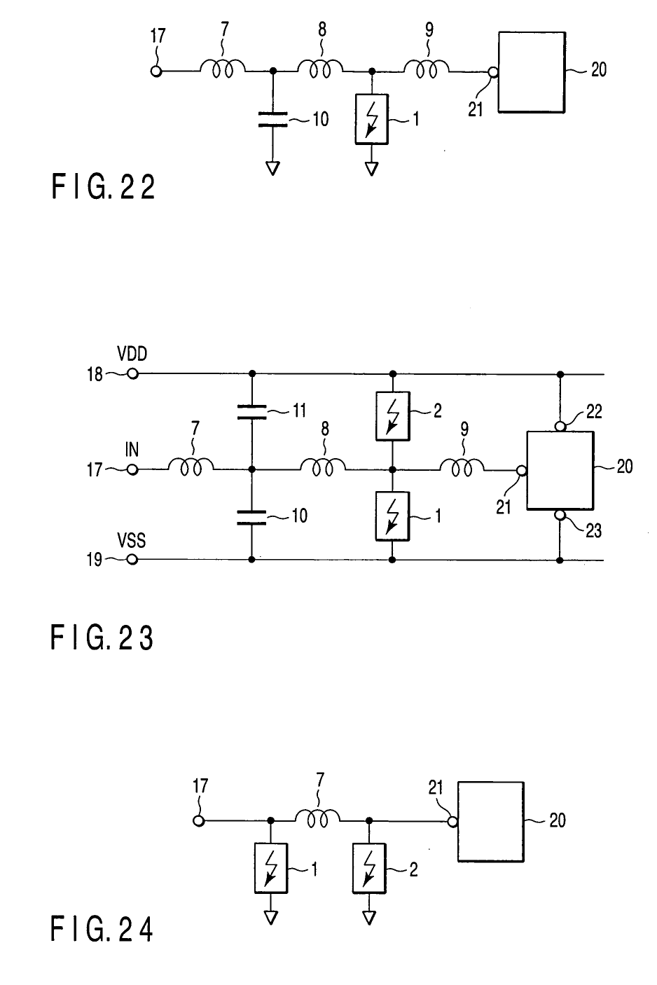

FIG. 22 shows a modification of the second embodiment, and the first protection device 1 is replaced with a capacitor 10 for ESD protection in the embodiment shown in FIG. 16. When the capacitor is used instead of the ESD protection device requiring a large area, the required area can be reduced, and an advantage similar to that of the embodiment of FIG. 16 is obtained. It is to be noted that the protection circuit of FIG. 22 is symmetrical between the input/output terminals in terms of the equivalent circuit.

FIG. 23 shows a more practical circuit configuration of the above-described modification. The power supply terminal VDD 18 and ground terminal VSS 19 are added to the circuit of FIG. 22, and the second protection device 2 is added between the power supply VDD and the connection node of the protection devices 8, 9. Therefore, the configuration becomes effective not only when the ESD is applied between the input terminal 17 and the VSS terminal 19 but also when the ESD is applied between the input terminal 17 and the VDD terminal 18. It is to be noted that the circuit diagram of FIG. 23 is represented by the equivalent circuit as shown in FIG. 22, such that the ESD devices 1, 2 are inserted between the transmission line and the reference potential (VSS or VDD).

In this manner, in the first and second embodiments, the T-type filter including the inductor and ESD protection device is a basic configuration, the filters are connected in multi-stages, an appropriate value of the inductor is selected, and thus an upper limit frequency of the low-pass filter can be set to an optional value. Accordingly, it is possible to realize an ESD protection circuit having a broad pass band as compared with the prior art.

### THIRD EMBODIMENT

FIG. 24 is a circuit diagram of the ESD protection circuit according to a third embodiment of the present invention. The input/output terminal 17 is connected to one end of the ESD protection device 1 and one end of the inductor 7, and the other end of the inductor 7 is connected to one end of the ESD protection device 2 and the output terminal 21. The output terminal 21 is connected to the internal circuit 20. The other end of each of the ESD protection devices 1, 2 is connected to a reference potential.

In the above-described configuration, two ESD protection devices and one inductor are connected in a π-type, and the configuration is symmetrical between the input terminal 17 and the output terminal 21. This configuration also operates as a low-pass filter or a band-pass filter, when the inductance value is appropriately designed. The output voltage drop by the parasitic capacitance of the ESD protection device can be largely compensated for.

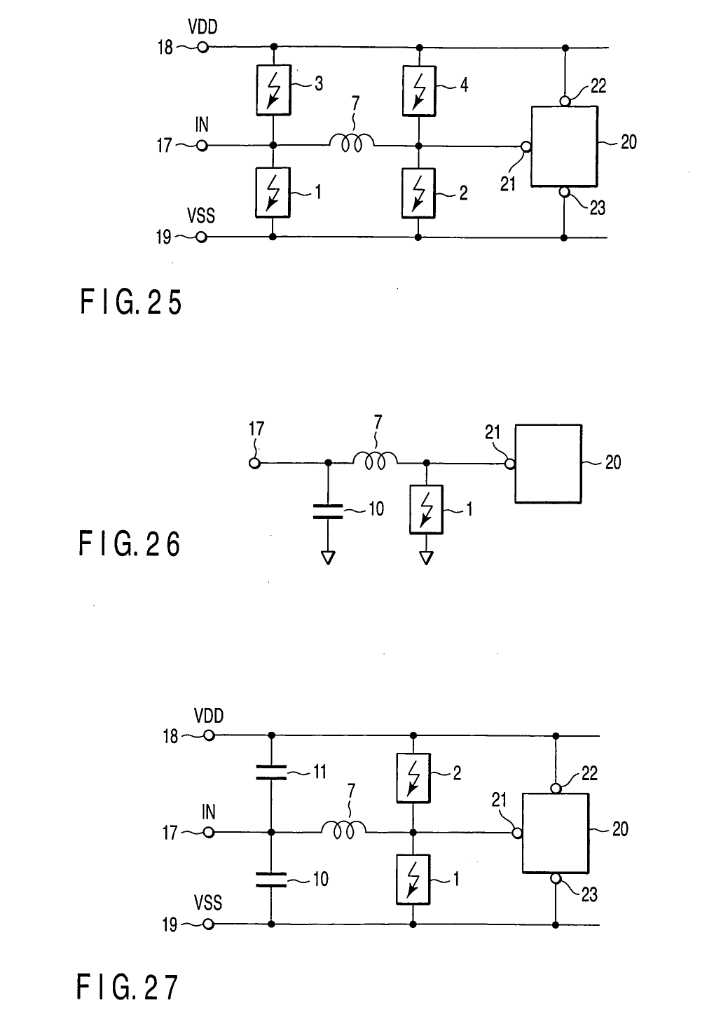

FIG. 25 shows a more practical circuit configuration of the third embodiment. The power supply terminal VDD 18 and ground terminal VSS 19 are added to the circuit of FIG. 24, and third and fourth protection devices 3, 4 are added between the power supply VDD and the opposite ends of the inductor 7. Therefore, the configuration becomes effective not only when the ESD is applied between the input terminal 17 and the VSS terminal 19 but also when the ESD is applied between the input terminal 17 and the VDD terminal 18. It is to be noted that the circuit diagram of FIG. 25 is represented by the equivalent circuit as shown in FIG. 24, such that the ESD devices 1, 2 are inserted between the transmission line and the reference potential line (VSS or VDD).

FIG. 26 is a circuit diagram of the ESD protection circuit according to a first modification of the third embodiment. That is, the input terminal 17 is connected to one end of the capacitor 10 for the ESD protection and one end of the inductor 7, and the other end of the inductor 7 is connected to the ESD protection device 1 and the output terminal 21. The other end of each of the capacitor 10 and the protection device 1 is connected to the reference potential.

The first modification corresponds to an example in which the ESD protection device 1 connected to the input terminal 17 in FIG. 24 is replaced by the capacitor 10. In this case, the capacitor 10 operates as an electrostatic discharge protection device. One of the ESD protection devices having enlarged areas is replaced with the capacitor, so that an advantage similar to that of the embodiment of FIG. 24 is obtained.

FIG. 27 shows a more practical circuit configuration of the first modification. The power supply terminal VDD 18 and ground terminal VSS 19 are added to the circuit of FIG. 26, a capacitor 11 is added between the power supply VDD and the input terminal 17, and the second protection device 2 is added between the power supply VDD and the output terminal 21 of the internal circuit 20. Therefore, the configuration becomes effective not only when the ESD is applied between the input terminal 17 and the VSS terminal 19 but also when the ESD is applied between the input terminal 17 and the VDD terminal 18. It is to be noted that the circuit diagram of FIG. 27 is represented by the equivalent circuit as shown in FIG. 26, such that the ESD devices 1, 2 are inserted between the transmission line and the reference potential (VSS or VDD).

FIG. 28 is a circuit diagram of the ESD protection circuit according to a second modification of the third embodiment. When the protection devices 1, 2 and the parasitic capacitances thereof are different with each other, a restriction is imposed on a circuit design. However, in the second modification, when the capacitor 10 is connected in parallel with the ESD protection device 2 on the side of the internal circuit, it is possible to relax the restriction on the circuit design. A parallel circuit consisting of the second protection device 2 and capacitor 10 is equivalent to a capacitor which functions as the protection device. Therefore, it can be considered that the circuit has a symmetrical form between the input terminal 17 and the output terminal 21.

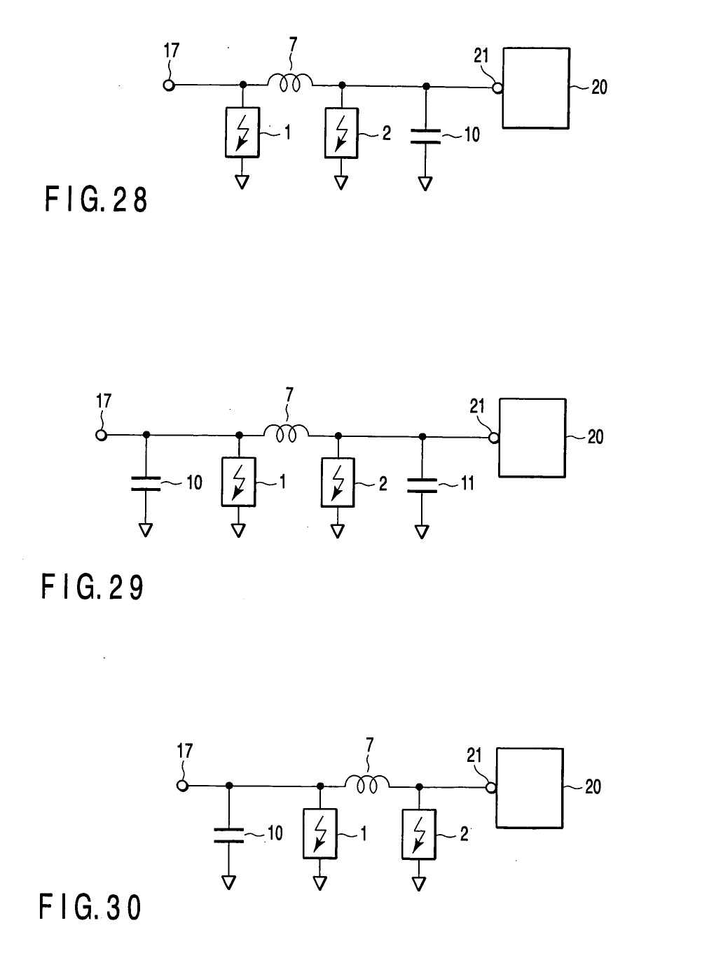

FIG. 29 is a circuit diagram of the ESD protection circuit according to a third modification of the third embodiment. When the ESD protection devices 1, 2 and the parasitic capacitances thereof are different with each other, a restriction to the inductance of the inductor 7 is imposed on the circuit design, and it is difficult to design an appropriate parameter. However, in the third modification, when the capacitors 10 and 11 are connected in parallel with the ESD protection devices 1, 2, a degree of freedom in the circuit design increases, and the design process is facilitated.

FIG. 30 is a circuit diagram of the ESD protection circuit according to a fourth modification of the third embodiment. Unlike the third modification, the capacitor 10 is connected in parallel with the ESD protection device 1 on the side of the input terminal 17, and an advantage similar to that of the third modification is obtained. Even in the first to fourth modifications, it can be considered that the circuit is symmetrical between the input terminal 17 and the output terminal 21 in terms of the equivalent circuit.

### FOURTH EMBODIMENT

FIG. 31 is a circuit diagram of the ESD protection circuit according to a fourth embodiment of the present invention. The circuit corresponds to a circuit in which the number of stages of the π-type filter of the third embodiment shown in FIG. 24 is increased. The input/output terminal 17 is connected to one end of the first protection device 1 and one end of the inductor 7, the other end of the inductor 7 is connected to one end of the second protection device 2 and one end of the inductor 8, and the other end of the inductor 8 is connected to one end of the third protection device 3 and the output terminal 21 connected to the internal circuit 20. The other end of each of the protection devices 1, 2, 3 is applied with the reference potential.

Even in the above-described configuration, the protection circuit is formed to be symmetrical between the input terminal 17 and the output terminal 21, and it is possible to further expand the optimum range of the frequency characteristics as compared with the third embodiment.

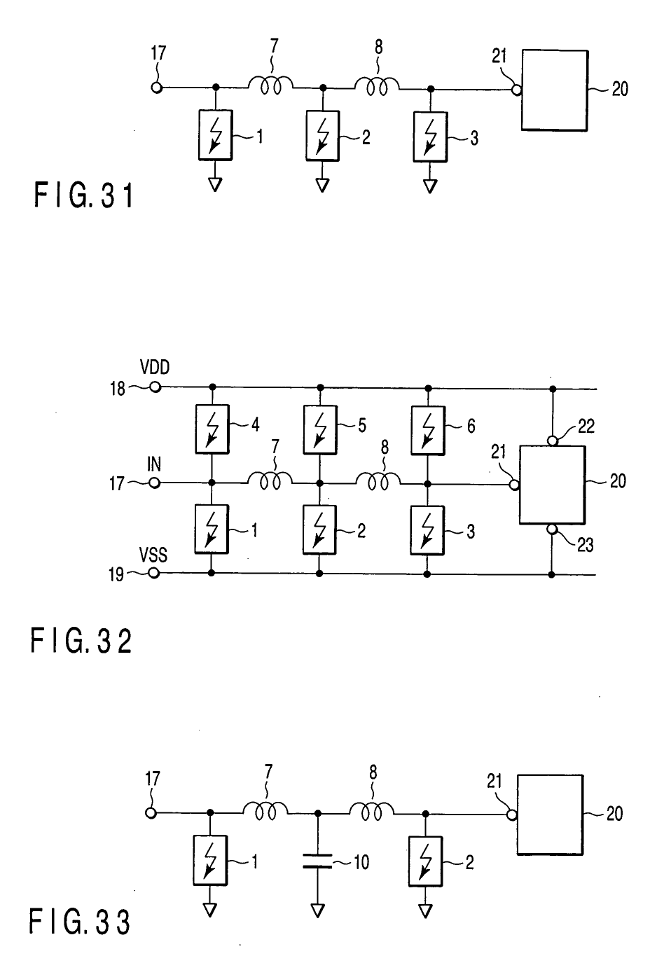

FIG. 32 shows a more practical circuit configuration of the fourth embodiment. The power supply terminal VDD 18 and ground terminal VSS 19 are added to the circuit of FIG. 31, and the second protection devices 4, 5, 6 are added between the power supply VDD and the opposite ends and connection node of the inductors 7, 8. Therefore, the configuration becomes effective not only when the ESD is applied between the input terminal 17 and the VSS terminal 19 but also when the ESD is applied between the input terminal 17 and the VDD terminal 18. It is to be noted that the equivalent circuit of FIG. 32 is as shown in FIG. 31.

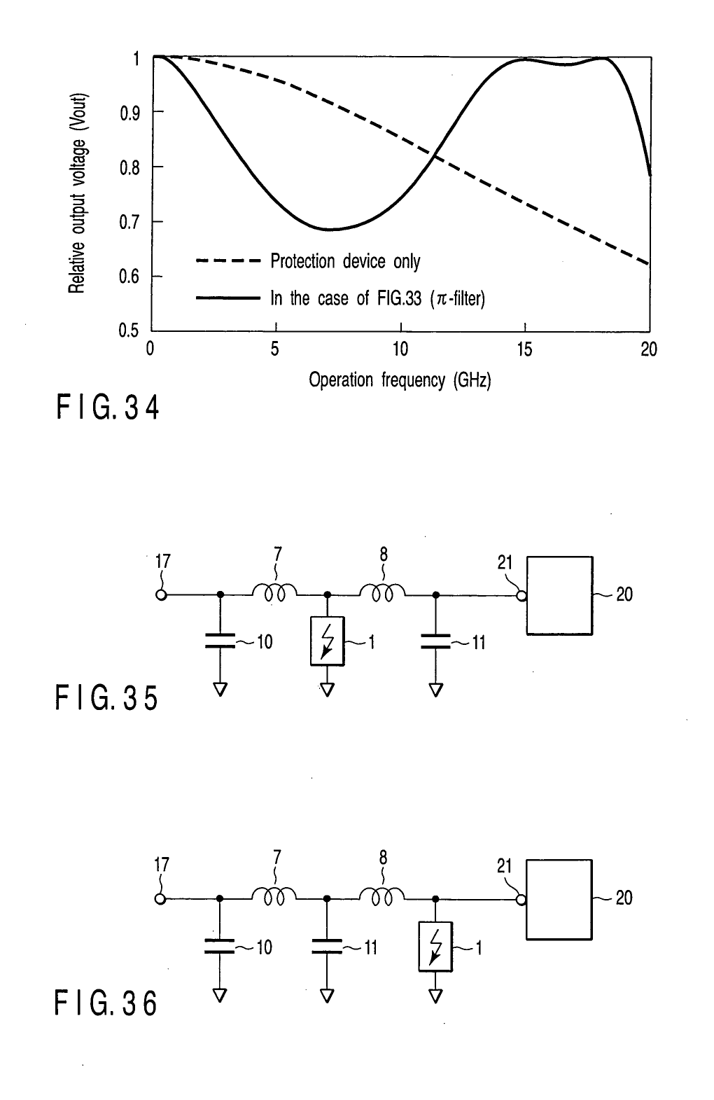

FIG. 33 is a circuit diagram of the protection circuit according to a first modification of the fourth embodiment. The second protection device 2 of FIG. 31 is replaced with the capacitor 10, and the third protection device 3 is renumbered as the second protection device 2.

Assuming that the parasitic capacitance of each of the ESD protection devices 1, 2 is 0.4 pF, the inductance of each of the inductors 7, 8 is 0.3 nH, and the capacitance of the capacitor 10 is 1.3 pF in the above-described circuit configuration, calculated values are shown in FIG. 34. The figure shows the characteristic of only the ESD protection device with 0.4 pF as a comparative example. In the protection circuit of FIG. 33, the output voltage is 1V over a frequency range of 14 to 18 GHz, and the band-pass characteristic is indicated. This characteristic cannot be realized by the configuration and design method (e.g., FIG. 43) of a transmission line type, and can be realized first by the present embodiment.

FIG. 35 is a circuit diagram of the ESD protection circuit according to a second modification of the fourth embodiment. In FIG. 31, the first, third protection devices 1, 3 are replaced with the capacitors 10, 11 for electrostatic discharge protection. By the use of the capacitor instead of the ESD protection device requiring a large area, the required area can be reduced, and an advantage similar to that of the embodiment of FIG. 31 is obtained.

FIG. 36 is a circuit diagram of the ESD protection circuit according to a third modification of the fourth embodiment. The first and second protection devices 1, 2 in FIG. 31 are replaced with the capacitors 10, 11 for the ESD protection, respectively. Even in this configuration, an advantage similar to that of the embodiment of FIG. 31 is obtained.

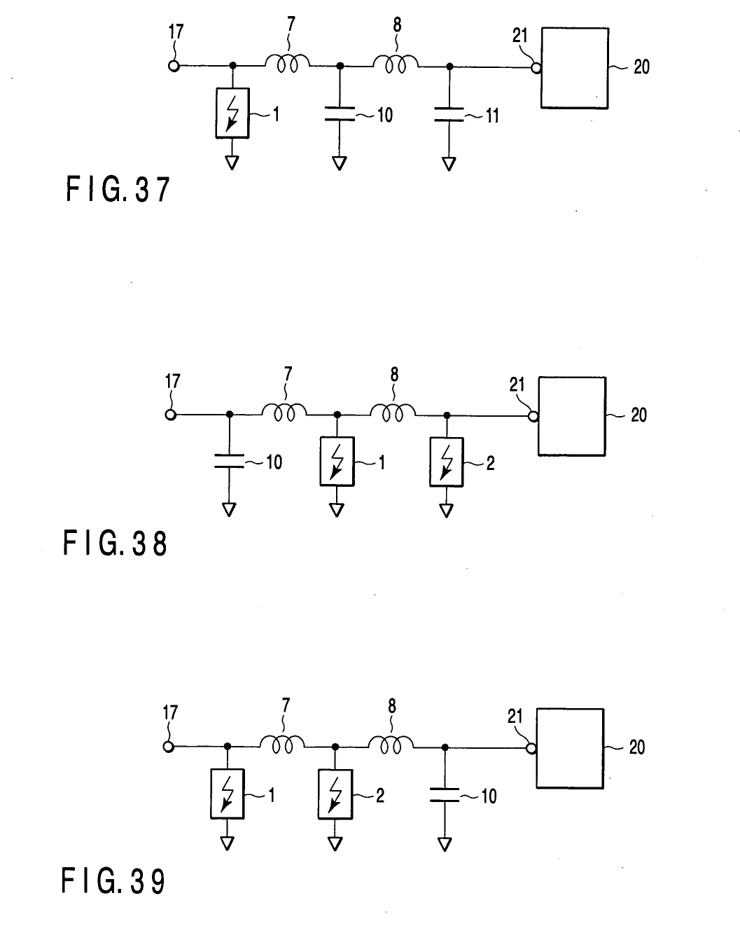

FIG. 37 is a circuit diagram of the ESD protection circuit according to a fourth modification of the fourth embodiment. The second and third protection devices 2, 3 in FIG. 31 are replaced with the capacitors 10, 11 for the ESD protection, respectively. Even in this configuration, an advantage similar to that of the embodiment of FIG. 31 is obtained.

FIG. 38 is a circuit diagram of the ESD protection circuit according to a fifth modification of the fourth embodiment. The first protection device 1 in FIG. 31 is replaced with the capacitor 10. Even in this configuration, an advantage similar to that of the embodiment of FIG. 31 is obtained.

FIG. 39 is a circuit diagram of the ESD protection circuit according to a sixth modification of the fourth embodiment. The third protection device 3 in FIG. 31 is replaced with the capacitor 10. Even in this configuration, an advantage similar to that of the embodiment of FIG. 31 is obtained. It is to be noted that even the protection circuits of the first to sixth modifications have a symmetrical configuration between input and output in terms of the equivalent circuit.

### APPLICATION EXAMPLE

Here, an application example of the ESD protection circuit of the present invention will be described.

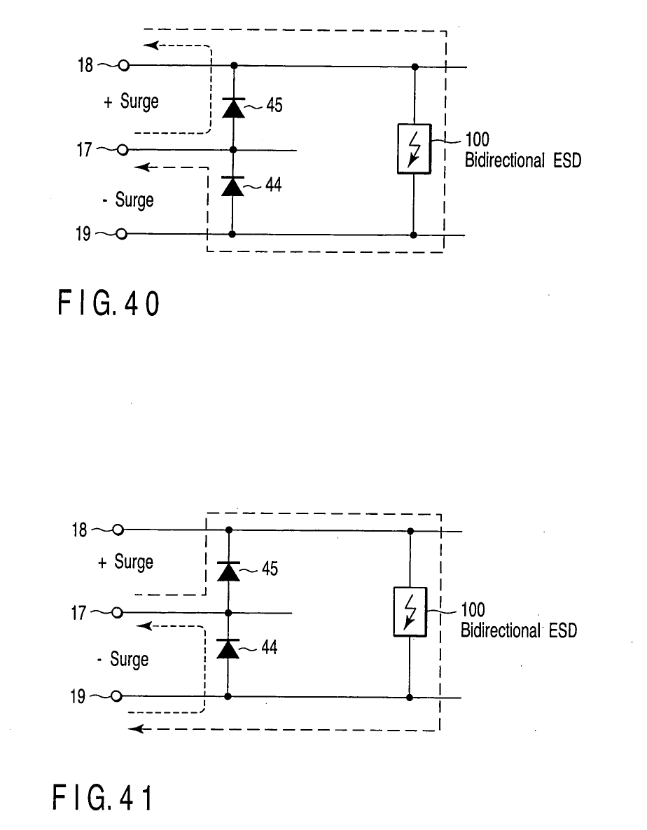

There is also a method in which as the ESD protection circuit of a high-speed I/O circuit, as shown in FIGS. 40 and 41, a diode 45 is connected between the input terminal 17 and the power supply terminal VDD 18, a diode 44 is connected between the input terminal 17 and the ground terminal VSS 19, and an ESD protection circuit 100 is disposed between the power supply terminal VDD 18 and the ground terminal VSS 19.

Here, the diodes 45, 44 fulfill a function of releasing the static electricity applied to the input terminal 17 to the power supply VDD and the ground potential line VSS, change a discharging direction (a direction of a surge current) by polarity of the applied static electricity, and are therefore sometimes referred to as current directors. In this case, whenever currents flow through the diodes 44, 45, the forward-direction characteristics of the diodes are used.

FIG. 40 shows a surge current path in a case where the ESD is applied between the input terminal 17 and the power supply terminal VDD 18, a short dashed line shows a case where a positive voltage (+) is applied to the input terminal 17, and a long dashed line shows a case where a negative voltage (−) is applied to the input terminal 17. FIG. 41 shows a current path in a case where the ESD is applied between the input terminal 17 and the ground terminal VSS 19, a short dashed line shows a case where a negative voltage (−) is applied to the input terminal 17, and a long dashed line shows a case where a positive voltage (+) is applied to the input terminal 17. It is to be noted that in FIGS. 40 and 41, a device capable of bidirectionally discharging electricity needs to be used as the ESD protection circuit 100, but can be realized, for example, by means for connecting a protection device having a thyristor structure to that having a diode structure in a reverse direction and in parallel with each other.

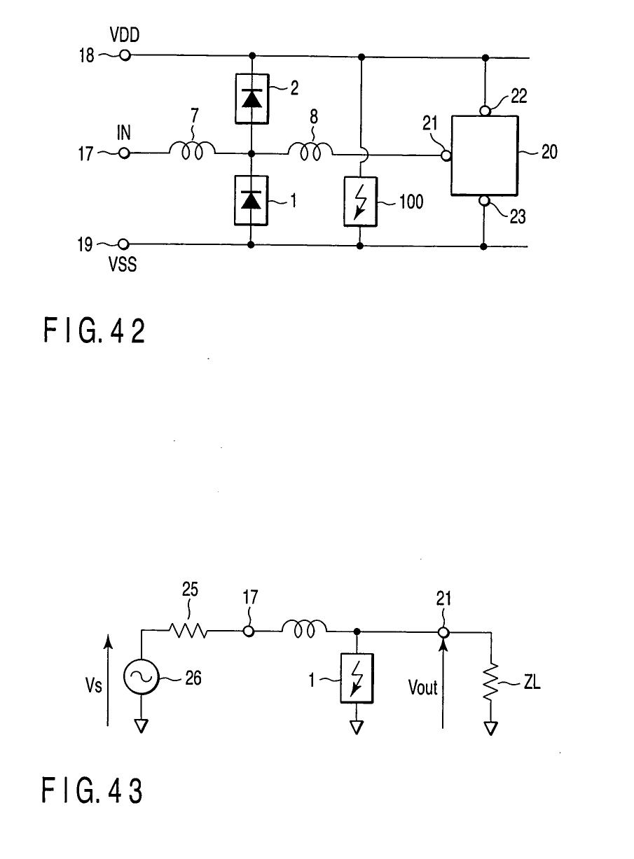

FIG. 42 is a circuit diagram of a case where the protection circuit of the embodiment of FIG. 15 is applied to the input circuit. In this case, the devices having the diode structure are used as the ESD protection devices 1, 2, the functions of the diodes 44, 45 shown in FIG. 40 or 41 are allocated, and the bidirectional ESD protection device 100 is added between VDD and VSS. By this configuration, an ESD protection circuit can be realized which produces less signal degradation of a high-speed, high-frequency signal.

In this manner, according to the embodiments of the present invention, when a circuit constant is appropriately selected, a low-pass type, a band-pass type, and characteristics can be all easily realized. In all the embodiments, the inductor may also be formed of a transmission line or a metal wiring.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electrostatic discharge protection circuit comprising:
an input terminal;
an output terminal connected to the input terminal via a transmission line, and connected to a circuit to be protected; and
a filter circuit disposed in the transmission line,
the filter circuit including:
at least one inductor disposed in the transmission line between the input terminal and the output terminal, and connected in series when a plurality of inductors are arranged; and
at least one electrostatic discharge protection device connected between the transmission line and a reference potential line, the filter circuit being symmetrically configured in terms of an equivalent circuit between the input terminal and the output terminal.

2. The electrostatic discharge protection circuit according to claim 1, wherein the filter circuit includes two inductors connected between the input terminal and the output terminal, and an electrostatic discharge protection device connected between a portion of the transmission line and the reference potential line, the portion of the transmission line being a connecting portion between the two inductances.

3. The electrostatic discharge protection circuit according to claim 2, wherein the electrostatic discharge protection device is replaced with a capacitor for electrostatic discharge protection.

4. The electrostatic discharge protection circuit according to claim 1, wherein the filter circuit includes one inductor disposed in series with the transmission line between the input terminal and the output terminal, and two electrostatic discharge protection devices connected between opposite ends of the one inductor and the reference potential line.

5. The electrostatic discharge protection circuit according to claim 4, wherein one of the two electrostatic discharge protection devices is replaced with a capacitor for electrostatic discharge protection.

6. The electrostatic discharge protection circuit according to claim 4, wherein a capacitor for discharge protection electrostatic is connected in parallel with at least one of the two electrostatic discharge protection devices.

7. The electrostatic discharge protection circuit according to claim 1, wherein the electrostatic discharge protection device includes a MOSFET.

8. The electrostatic discharge protection circuit according to claim 1, wherein the electrostatic discharge protection device includes a thyristor.

9. The electrostatic discharge protection circuit according to claim 1, wherein the electrostatic discharge protection device includes a diode.

10. An electrostatic discharge protection circuit comprising:
a first power supply line to which a power voltage is supplied;
a second power supply line connected to ground potential;
an internal circuit connected to the first power supply line and the second power supply line, and having an internal input terminal;
a bidirectional electrostatic discharge protection device connected between the first power supply line and the second power supply line;
a first and a second unidirectional electrostatic discharge protection device connected in series between the first power supply line and the second power supply line;
an external input terminal to which an external signal is supplied;
a first inductor connected between the external input terminal and a connection node of the first and the second unidirectional electrostatic discharge protection device; and
a second inductor connected between the connection node of the first and the second unidirectional electrostatic discharge protection device and the internal input terminal.

11. The electrostatic discharge protection circuit according to claim 10, wherein the first unidirectional electrostatic discharge protection device includes a first diode whose cathode is connected to the first power supply line and whose anode is connected to the connection node, and the second unidirectional electrostatic discharge protection device includes a second diode whose anode is connected to the second power supply line and whose cathode is connected to the connection node.

12. A semiconductor integrated circuit comprising:
a semiconductor substrate;
a reference potential line formed on the semiconductor substrate;
an input terminal which is formed on the semiconductor substrate and which receives an external input signal;
an output terminal which is formed on the semiconductor substrate and which is connected to the input terminal via a transmission line and which supplies an internal input signal;
a filter circuit disposed in the transmission line,
the filter circuit including:
at least one inductor disposed in the transmission line between the input terminal and the output terminal, and connected in series when a plurality of inductors are arranged;
at least one electrostatic discharge protection device connected between the transmission line and a reference potential line, the filter circuit being symmetrically configured in terms of an equivalent circuit between the input terminal and the output terminal; and
an internal circuit to which the internal input signal is supplied from the output terminal.

13. The semiconductor integrated circuit according to claim 12, wherein the filter circuit includes two inductors connected between the input terminal and the output terminal, and an electrostatic discharge protection device connected between a part of the transmission line and the reference potential line, the portion of the transmission line being a connecting portion between the two inductances.

14. The semiconductor integrated circuit according to claim 13, wherein the electrostatic discharge protection device is replaced with a capacitor for electrostatic discharge protection.

15. The semiconductor integrated circuit according to claim 12, wherein the filter circuit includes an inductor disposed in series with the transmission line between the input terminal and the output terminal, and two electrostatic discharge protection devices connected between opposite ends of the inductor and the reference potential line.

16. The semiconductor integrated circuit according to claim 15, wherein one of the two electrostatic discharge protection devices is replaced with a capacitor for electrostatic discharge protection.

17. The semiconductor integrated circuit according to claim 15, wherein a capacitor for electrostatic discharge protection is connected in parallel with at least one of the two electrostatic discharge protection devices.

18. The semiconductor integrated circuit according to claim 12, wherein the electrostatic discharge protection device includes a MOSFET.

19. The semiconductor integrated circuit according to claim 12, wherein the electrostatic discharge protection device includes a thyristor.

20. The semiconductor integrated circuit according to claim 12, wherein the electrostatic discharge protection device includes a diode.
